(19) United States
(12) Patent Application Publication
(10) Pub. No.: US 2009/0161908 A1
(43) Pub. Date: Jun. 25, 2009

(54) Recoverable Marks for Films

(76) Inventors: Mike Arthur Derrenbrger, Valencia, CA (US); Jian Zhao, North Attleboro, MA (US)

Correspondence Address: Thomson Licensing LLC, P.O. Box 5312, Two Independence Way, PRINCETON, NJ, 08543-5312, US

(21) Appl. No.: 11/992,170

(22) PCT Filed: Sep. 21, 2005
(86) PCT No.: PCT/US05/33674

§ 371 Date: Mar. 18, 2008

(51) Int. Cl. G06K 9/00; H04N 1/32

(52) U.S. Cl. 382/100; 283/113

(57) ABSTRACT

Techniques for making and using recoverable marks for films. The recoverable mark consists of a portion of a film to which a watermark that is imperceptible to viewers of the film has been applied and an original mark that is applied to the portion of the film with the watermark. Application of the original mark to the portion modifies the watermark, and consequently, if the original mark is altered, the modifications to the watermark preserve the original mark. In one application of the technique, the watermark is applied to a digital master of the film, a master analog copy is made from the digital master, and a unique original mark is applied to each of the copies made from the master analog copy.

### FIELD OF THE INVENTION

The invention relates generally to security features in objects such as documents, films, and recordings that are derived from digital representations and more specifically to the problem of recovering the original form of a security mark belonging to the object after the security mark has been destroyed or altered.

### BACKGROUND OF THE INVENTION

A prerequisite for a commercial society is being able to distinguish authentic items from false, counterfeit, or stolen items. One way of doing this is to include identification marks on the item which show the item's authenticity. The marks may be visible to the ordinary observer or invisible; one large class of such invisible identification marks is watermarks. A problem with any kind of mark, visible or invisible, is that a thief may delete or modify the identification mark. If the thief is skillful, it will no longer be possible to determine what the mark was. The loss of the mark, of course, greatly complicates the task of determining the ownership of the object and of how the object came into the hands of the thief.

One large class of identification marks is marks that are added to individual copies of an item to distinguish the copies from each other. If each copy has a unique mark and the source of the copy keeps track of the unique mark and to whom it gave the copy with the unique mark, when an illegal copy of the object that bears the unique mark appears, the source of the copy has at least some notion of where to begin looking for the source of the illegal copy.

An example of this use of marks comes from the film industry. FIG. 6 shows how each copy of a film is marked with a film mark when the copy is made. Copying process 601 begins with an analog master copy 603 of the film that has been made from the film's digital master. Master copy 603 is placed in a film copy machine 605 and used to make a number 1 . . . n of analog copies 607. Each of these copies then undergoes a film mark insertion operation 609 in which a film mark 611(i) which is unique to copy 607(i) is inserted into copy 607(i) at locations in the film which are known only to the maker of the film. The result of the insertion process is marked copy 611(i). The film mark is invisible to viewers of the film, and is, thus, a kind of secret watermark. In some cases, the film mark is made by using a laser to burn tiny holes into the film; in others, tiny marks are made on the film by using lasers to change the colors of the dyes in the film to produce spots.

The owner of the copy 611(i) records the film mark, its location in the film, and the party that received copy 611(i). If illegal copies are made of copy 611(i), either by using a film copy machine 605 or by making a video or movie of the film while it is being shown, the copies will carry the film mark. At a minimum, that permits the owner to determine that copy 611(i) was the source of the illegal copies and to take measures with regard to the party that had custody of copy 611(i) when the illegal copying occurred that will prevent such copying in the future.

A difficulty with film marks is that if they are sufficiently large and different enough from their surroundings to survive the copying process that produced the illegal copy, they can be located by a careful manual or digital examination of the illegal copy and removed. In the case of film marks made by putting holes in the film, the marks can be patched and tinted to match the background at their locations. With the spots, simple tinting suffices to remove the mark. Once that is done, the owner of marked copy 611(i) can no longer determine the marked copy from which the illegal copies were made.

Earlier work which is relevant to the above problem is disclosed in U.S. Pat. No. 6,782,116 J. Zhao, et al., Apparatus and methods for improving detection of watermarks in content that has undergone a lossy transformation, issued 24 Aug., 2004, and in PCT/US03/15168, Zhao, et al., Visible authentication patterns for printed documents, filed 14 May, 203 and having a priority date of 14 May 2002. Disclosure from these two sources in included in the following, beginning with a description from U.S. Pat. No. 6,782,116 of how watermarks may be used to detect alterations in documents and followed by a description from PCT/US03/15168 of a technique for distinguishing between legal and illegal modifications of documents that use the visual authentication patterns, or VAPs described in PCT/US03/15168.

Generally speaking, authentication techniques for documents which involve watermarks use the watermark to hide some kind of authentication information for the document in a graphical element in the document. An example is using the watermark to hide a digest made from the document's character codes, as explained in U.S. Pat. No. 6,243,480, Zhao, et al., Digital authentication with digital and analog documents, issued 5 Jun. 2001. A difficulty with techniques that use watermarks to hide authentication information in a graphical element of a document is that wear and tear on the document often renders the watermark unreadable.

U.S. Pat. No. 6,782,116 J. Zhao, et al., Apparatus and methods for improving detection of watermarks in content that has undergone a lossy transformation, issued 24 Aug., 2004 explores ways of obtaining at least some information from unreadable watermarks and ways of making watermarks more robust in the face of lossy transformations such as those caused by wear and tear on a document. Among the things that the inventors of U.S. Pat. No. 6,782,116 realized in the course of their work were first, that a watermark's mere presence could be used to authenticate a document, and second, that the mere presence of a watermark could be used to discover where a document had been altered. The portions of U.S. Pat. No. 6,782,116 that deal with these realizations follow.

The standard application of digital watermarks is to hide a message in a digital representation. One of the uses of such a message is validating or authenticating the digital representation: the digital representation being validated is believed to contain a watermark which contains a particular message; the watermark is read and its contents are compared with the particular message. If they agree, the digital representation is valid or authentic. When the digital representation has undergone a lossy transformation, the watermark may become unreadable; the techniques discussed in U.S. Ser. No. 10/287,206 permit limited validation or authentication in such situations. A general problem with validation by means of messages contained in watermarks is that validation often involves long messages such as social security numbers or account numbers, while watermarks containing such long messages are less robust than watermarks containing short messages, and are therefore more likely to be rendered unreadable by lossy transformations.

A solution to this general problem is based on the observation that for validation or authentication purposes, there is no need that the watermark actually contain the message that forms the basis for the validation or authentication; all that is required is that a given watermark will be present in a digital representation only if the watermark was made using the message that forms the basis for the validation. In that case, there is no need for the watermark to be readable; instead, the mere presence of the watermark permits the digital representation to be validated. Moreover, because it is the watermark's presence and not its content that shows that the digital representation is valid or authentic, the watermark's content need do nothing more than indicate the watermark's presence and need be no longer than is required to do that; indeed, the watermark vector for a such a watermark need only specify the value of a single bit. This in turn makes such watermarks far more robust than watermarks that contain the message that forms the basis for the validation or authentication.

One way of making a watermark whose mere presence in a digital representation validates or authenticates the digital representation is to use the message to determine the location of the watermark in the digital representation. This is shown at 801 in FIG. 8. A key function 805 (ƒ) is used to make a key 806 (K2) from a message 803 (m): K2=ƒ(m); where required, the function 805 may use a secret key K1 as well as m to make the key: K2=ƒ(K1, m). Key 806 is then provided to watermark embedder 809 along with a short (minimum 1 bit) watermark vector WM 807 and watermark embedder 809 embeds a watermark made using watermark vector 807 at the locations in watermarked digital representation 813 indicated by key 806. The watermark is shown in FIG. 8 by the dotted boxes labeled 807 in digital representation 813. Since message 803 is now no longer contained in the watermark, but instead used to make key 806 and short watermark vector 807 need only be 1 bit in length, the length of the message has no effect whatever on the robustness of the watermark. As is well known in mathematics, there are many functions which can be used to generate key 806 from message 803 in a fashion such that key 806, and thus the watermark made with it, is unique to the message. The degree of uniqueness required may, of course, vary with the application. In some cases, the function may be an identity function, i.e., the key is the message itself. An advantage of the technique is that the function determines the length of the watermark key, and, thus, the key can be made as long as is required for a particular application.

FIG. 9 shows at 901 a system that determines whether a digital representation 903 that is believed to contain a watermark made in the manner described above is authentic. Digital representation 903 contains a set of locations 905 that should contain watermark vector 807 if digital representation 903 is, in fact, derived from digital representation 813. The locations are at positions which in digital representation 813 were determined by key 806. The system that is doing the authentication obtains message 803 and also obtains or is in possession of key function 805. Key function 805 is applied to message 803 to produce key 806 as described above. The system then provides key 806 to watermark reader 907, which uses it to find locations 905. When a location is found, it is output to comparator 911, as shown at 909. Short watermark vector 807 is also in possession of system 901, and it is provided to comparator 911 to compare with the value of each of the locations 905 in turn. The result 912 of each comparison goes to aggregator 913, where the results are aggregated to produce overall result 915, which indicates whether the watermark that was embedded in digital representation 813 is present in digital representation 903. Comparator 911 and aggregator 913 can use any of the techniques previously discussed with regard to unreadable watermarks for doing the comparison and the aggregation. As described below for the techniques used with unreadable watermarks, the pattern of locations 905 that match the watermark in digital representation 813 may be used to show locations at which digital representation 903 has been altered.

In some applications, aggregator 913 will produce a visual result of the comparison. An example of such a comparison is shown at 501 in FIG. 5. There, the blocks to which the watermark was applied have different shades depending on the extent to which the presence of the watermark was detected. The lighter the block is, the stronger the presence of the watermark in the block. Because image 501 has undergone lossy transformations, the distribution of blocks with strong watermarks will not be the same as in the original, but the errors caused by the lossy transformations are random, and consequently, if the image is authentic, all areas which contain the watermark should have roughly the same distribution of light blocks as shown at 501. This visualization technique can of course be used as well with watermarks in which the message determines the watermark's contents.

One way of attacking a digital document or an analog form made from the digital document is locally modifying an image in the document or form to change its semantic content. Examples of local modifications can be:
modifying the plate number on the image of a car captured by a DVR on the scene of an accident/crime; or
modifying areas of the portrait on an ID card; or
replacing the portrait on an ID document.

If the document or form is watermarked, the counterfeiter's goal is to change the semantic content of the digital document or form without rendering the watermark incorrect or unreadable. In general, when a watermark is robust enough to be readable, it will not be difficult for the counterfeiter to make small changes in the document or form without rendering the watermark incorrect or unreadable. On the other hand, the very robustness of the watermark makes it useful for detecting and tracking alterations.

In order to use a watermark to locate an alteration, one need only know the locations at which the watermark is expected to be and its watermark vector. Since the technique does not require that the watermark have any particular content, the watermark vector need only be a single bit. Once the detector knows the watermark locations and the watermark vector, the detector can use the watermark vector w,′ which is a replica of the original watermark's watermark vector w and compare w′ with the watermark w″ in the questionable content. Differences between w′ and w″ may show whether the digital document or analog form, that is the source of the questionable content, has been modified and if so, which portions were modified.

In more detail, the detector compares the watermark vector w″ in each subpart (termed herein a block) of the digital document or analog form with vector w′. The comparison indicates whether each block of the document or form holds the correct watermark information. In a digital document, if there has been no alteration, most blocks will contain the correct watermark information. With analog forms, the print-and-scan process deteriorates the watermark, and consequently, not all blocks will hold the correct watermark information (e.g. there can be on the order of 20% to 40% errors). These printing and scanning errors are generally of a random nature and, therefore, can be expected to be distributed more or less uniformly on the analog form. Thus, if the image has been locally altered and has thereby lost its watermark in the altered areas, the watermark detector will respond to the altered areas in the same way that it responds to areas that are not watermarked. In doing so, the watermark detector detects the alteration. The technique can also be used to show the strength of the watermark in each area of the image.

The replica watermark vector used to detect alterations or watermark strength may come from any source. Examples include a copy of the original watermark vector, a copy of the original image, a watermark vector from the questionable content that has been successfully read, or a watermark vector which has been generated anew using the message and the key function. Adaptive embedding and detection may be used to increase the effectiveness of detecting alterations. For example, areas of the content that need special protection against change may receive watermarking of a greater strength than other areas of the content, and the greater strength of the watermarking in these areas may be taken into account when the watermarks are analyzed as described above. Of course, the technique as used to show the strength of the watermark in each area of the image may be employed to aid in the design of masks for adaptive embedding and detection.

Different techniques inspired by statistics, signal processing or pattern recognition can be applied to automatically detect areas that contain an abnormally large number of blocks that hold incorrect information (or no information at all). For example, one technique inspired by pattern recognition is to determine how incorrect blocks are connected to incorrect blocks, and extract those incorrect blocks whose connections to other incorrect blocks are higher than a threshold. Another technique would be to determine in all areas of size N×N of the analog form whether there are more than P incorrect blocks. Yet another technique from signal processing is to assign positive values to correct blocks and negative values to incorrect blocks and then low-pass filter the resulting matrix. The areas of the filtered matrix in which values are below a threshold are detected as having been altered. Finally, statistics can be applied in all approaches to characterize areas of the images that are not altered and those that are altered, and to determine detection parameters relatively to the user's expectation (e.g. minimum size of altered areas, probability of false alarm/rejection, etc). It is also possible to display to the user an image with the incorrect and correct blocks in different colors, to allow human interpretation of the data.

FIG. 5 shows the effect of alterations on watermark strength and also provides an example of a graphical way of showing altered areas. Here, image 501 was modified after it was watermarked by replacing the face in image 501 with another face, which was not watermarked in the way that the face in image 501 was watermarked. The result of the modification is image 502. When image 502 is compared with image 501, it will be seen that the facial area of image 502 is darker than the facial area of image 501. This, in turn, shows that the blocks in the facial area of image 502 are far more weakly watermarked than the blocks in the facial area of image 501. The weak watermark in the facial area of image 502 is, of course, a direct consequence of the modification. When a filter is applied that highlights areas with many weak blocks, the result is image 503, in which modified area 505 clearly stands out.

The foregoing realizations were followed by yet another realization: when a watermark's mere presence is being used to determine authenticity of an analog form, the watermark is being used as a contentless pattern. Since the pattern has no content, there is no longer any need for it to be invisible; instead, it can be added to the document as a visible element. In the following, visible patterns that are used for authentication are termed visible authentication patterns or VAPs. Because the VAP is visible, it is far easier to detect than a watermark. It is, however, still able to perform all of the authentication functions of invisible watermarks and, in addition, lets consumers of the document know that the document's authenticity is protected.

The following terminology will be used here and in the Detailed Description to clarify the relationships between digital representations and analog forms.

A digital representation of an object is a form of the object in which the object can be stored in and manipulated by a digital processing system. Objects may be or include as components documents, images, audio, video, or any other medium of which a digital representation can be made.

An analog form of a digital representation is the form of an object or component that results when the digital representation is output to an analog device such as a display, printer, or loudspeaker.

A digital recording of an analog form is a digital representation made from the analog form. The manner in which the digital recording is made depends upon the medium; for example, for a documents or an image, digital recording is done by digitizing an image made from an analog form of the document or image.

An original digital representation is a digital representation made or copied by someone authorized to do so; an original analog form is one made from an original digital representation.

A non-original digital representation is one that is made by digitally recording an analog form without authorization; a non-original analog form is made from a non-original digital representation or by photocopying an analog form.

A document will be given the special meaning of any analog form which is produced by a printing process, including documents in the more usual sense of the word, labels, packaging, and objects that are themselves imprinted. To the extent that reasonable analogies can be made, everything in the following that is said about documents may be applied also to other media. For example, an audio analog form may include an audible authentication pattern that is the audio equivalent of the VAP.

The paradox of the visible authentication pattern is that while the pattern is visible, a possible counterfeiter must not be able to modify the pattern so that it will authenticate a document that is not authentic. This end is achieved in a preferred embodiment by making the pattern noisy, i.e., a large part of the value of the pixels making up the pattern is or appears to be randomly determined. Because the pattern is noisy, it is impossible to tell what values the pixels making up the digital representation of the pattern should have without knowledge of the original digital representation of the pattern. On the other hand, given the original digital representation of a VAP, one can compare a digital recording of a VAP from a document with the VAP's original digital representation, determine how the recorded VAP has been altered with regard to the VAP's original digital representation, and can determine from the differences how the document in question has been altered. As will be seen in more detail in the following, alterations that can be detected include those involved in making non-original documents and those involved in altering information in a document.

FIG. 1 shows one way of making a visible authentication pattern and inserting it into a document. There are three steps:
generating a digital representation of the pattern, shown at 101;
an optional act of adding a visible logo or legend to the authentication pattern, shown at 107; and
inserting the authentication pattern into the document, shown at 113.

The original digital representation of the pattern 105 can be generated in any way which produces a result in which the pattern's pixels appear to have values with a strong random component. The digital representation of pattern 105 may be a gray scale pattern, or it may employ colored pixels. It is particularly useful to employ a key to generate the pattern; the key 103 is used as a seed for a pseudo-random number generator, which produces the sequence of values, which are given to the pixels in the pattern. Uses of the key will be explained in detail later. The original digital representation of pattern 105 may also include components, which aid in locating the pattern in a digital representation made by scanning a document that contains pattern 105. In pattern 105, black border 106 performs this function.

A visible logo or legend 109 can be added to the original digital representation of pattern 105 to make the original digital representation of pattern 111 without compromising pattern 105's noisiness because only a part of the value of the pixels making up the pattern need be randomly determined. Thus, the logo or legend can be superimposed on pattern 105 by manipulating the values of the pixels making the logo or legend in a way that preserves their randomness while causing the logo or legend to appear. For example, if pattern 105 is a gray scale pattern, the legend or logo can be made by making the pixels of the legend or logo uniformly darker or lighter relative to their original random values. The technique is similar to adding a visible watermark to an image, except that it preserves the noisiness of pattern 105.

Once the original digital representation of pattern 111 has been made, it is inserted into the original digital representation of the document 115, as shown at 113. When document 117 is printed from original digital representation 115, document 117 includes printed visible authentication pattern 119. Of course, the document may be printed onto a substrate that already has printed material on it. Thus, pattern 119 may be added to a preprinted substrate.

Certain classes of documents are always “modified” after they are printed. One common example of this is a check that is printed with blank fields that are filled in when the check is written. A problem with documents belonging to all of these classes is that what is placed in the filled-in fields may be altered later. Thus, even though the check itself is authentic, the semantic values of what was written in the blank fields may be changed. For example, a payee of a check can modify the amount on a check that is addressed to him (e.g. from “one hundred” to “nine hundred”), in a way that is difficult for a teller to notice.

This kind of problem is hard to solve because the forgers do not actually create counterfeit documents; instead, they alter the semantic value of authentic documents. The problem is made harder by the fact that the filled out authentic document already contains legal modifications. The problem is, how are the legal modifications to the document to be distinguished from later illegal modifications.

One of the solutions to this problem is forensic examination. If the teller suspects that the check has been modified, he can bring it to another authority for further examination. However, this task is manual, costly, and time-consuming and it is clearly not possible to apply it systematically to every document or check. Often, the counterfeiter forges a check by first erasing a part of the writing. For example, to modify the amount from “two hundred” to “nine hundred”, he will probably erase the “two” and modify it to “nine”. To erase handwriting, he will often use chemical products. Another possibility is to scrape the original amount from the check, repaint the background, and then write in the new amount.

Visible authentication patterns can be used to detect these illegal modifications. The general idea is to print a VAP in each of the areas of the document where we may want to detect illegal modifications. The legal modifications are then made by writing on the VAP. The precise, unique and uncopyable VAP structure can be used later on to detect modifications and to determine if the modifications are acceptable. The idea is that both writing on a VAP and erasing something written on a VAP produce detectable modifications of the VAP. Writing on the VAP destroys the pattern, as does scraping writing off of the VAP or applying a chemical erasing agent to the VAP. A VAP that is used in this fashion is termed in the following a modification detection pattern, or MDP.

How a MDP may be used to detect illegal modifications can be summarized as follows:
insert an MDP in each area of the document which needs to be protected against unauthorized modifications.
when verifying the authenticity of the document, first record an image of each of the MDPs in the document.
for each recorded MDP, compare the recorded MDP with the original digital representation of the MDP to detect areas where the MDP has been damaged.

The results of the comparison of the recorded MDP with the original digital representation of the MDP can be used in a number of ways:
display the results of the comparison with the damaged areas highlighted to a decision maker. This will show both the areas that contain writing and the erased areas.
display the results of the comparison with non-written damaged areas highlighted to the decision maker.
compare the size of the damaged area with the size of the area that has been written on, and if the difference is above a threshold, treat the field has having been modified.

FIG. 10 shows how a MDP can be used to detect modifications. At 1001 is shown a MDP 1002 that is used in an amount field for a document. As before, MDP 1002 is surrounded by black border 106. As shown at 1003, the amount 250 has been written into MDP 1002. At 1005 may be seen how a forger has modified the amount $250 to the amount $950 by erasing the “tail” of the 2 and adding a loop to make it into the number 9. To cover up the erasure, the forger has imitated the pattern of the MDP. The imitation is still visible in 1005, but even as shown, it is good enough to get by a harried teller and a skilled forger can easily make the imitation better.

The problem for the forger is that the erasure has destroyed the MDP. By scanning the MDP and locally analyzing it, it is possible to detect with high accuracy which part of the MDP has changed from the original. Erasures can be detected by finding areas in the MDP which contain neither text nor the original pattern. This is shown at 1009. Text areas are easy to find because they are typically color-uniformed and darker than the MDP. All that then need be done to find the erased areas is to compare the areas of the recorded MDP that do not contain text with the original digital representation of the MDP. The erased areas show up as parts of the recorded MDP that do not match the original digital representation, as shown at 1011. In a preferred embodiment, such non-matching parts appear in red.

A few more details on the algorithm for using an MDP to detect alteration of a document:
Making MDPs: A MDP may be made in any way that a VAP is made, but then the pixel values are increased to make the MDP brighter (otherwise, the text written on the MDP could not be easily distinguished from the MDP).
Use registration marks (e.g. black border or corner marks) to extract the recorded MDP from the document.
Detect text areas: A low-pass filter is applied to the recorded MDP, and pixels with values under a threshold are considered to be part of the text and legal modifications.
Detect modifications of the MDP: after local resynchronization is applied, a correlation coefficient is computed for each block of the MDP. As shown in 1009 one can see that the areas of the text and the areas of the illegal modification were altered.
By excluding the legal modifications (at 1003) from image 1001, several algorithms can be applied to detect the illegal modifications. One possible way is to first classify areas into modified or non-modified (by thresholding the local correlation), then apply a noise processing algorithm or low-pass filter that removes individual or non-significant modified areas. Region detection algorithms can also be applied to find significant modified regions. The result is displayed in 1009: the non-allowed modifications are displayed in red, while the allowed one (on the text) areas displayed in green.
Depending on the amount of non-allowed modifications, a decision can optionally be taken on the authenticity of the document to which the MDP belongs.

All that is required for using a VAP to detect alterations in an analog form is that there be an area in the analog form that has a pattern which will serve the purpose and an original digital representation of the pattern that can be compared with the pattern as recorded from the analog form. It will, thus, be possible in some cases to use a preexisting pattern in an analog form for the technique. More usually, though, the VAP will be included as part of the design of a new analog form. There is, of course, no need to hide the VAP in the analog form, and indeed in some cases, its presence may be advertised to reassure customers that illegitimate analog forms can be detected. On the other hand, the VAP can have any shape, and thus can easily be built into other features of the analog form.

The pattern can be a gray scale pattern or it can be a colored pattern. In the latter case, different color channels can be employed, for example RGB and YUV. The pattern can also be generated in various frequency domains, for example spatial, wavelet, DFT, or DCT domains.

The noisiness, i.e., random nature, of the VAP is what makes it difficult for counterfeiters and forgers to deal with it. Any technique which can produce a random or pseudo-random pattern will do to generate the VAP. In the preferred embodiment, generation is done by providing a value to a pseudo-random number generator which generates a sequence of random numbers that is unique for the value. The value thus serves as a key which may be used to generate new copies of the pattern. Different pseudo-random number generators may be used in different embodiments and the probabilistic frequency values for the generated random numbers can be taken from different probability distributions. The key can also be used to determine the locations in the VAP upon which analysis is performed. In some applications, the key used for designing the pattern may not be revealed to other parties. In that case, any useful way of distributing keys may be used, for example asymmetric keys or public-private key pairs.

What is needed is a technique which permits recovery of a film mark from an illegal copy even after the film mark has been removed. It is an object of the present invention to provide such a recovery technique.

### SUMMARY OF THE INVENTION

The object of the invention is attained by a recoverable mark that is associated with a copy of a film. The recoverable mark includes a portion of the copy which carries a watermark that is imperceptible to viewers of the copy of the film and an original mark. The original mark has been applied to the portion of the copy that carries the watermark and the application of the original mark to the portion of the copy has modified the watermark.

The original mark may be one or more holes in the portion of the copy of the film, may be made by discoloring dye in the portion of the copy of the film, or may be another watermark that has been applied to the portion of the copy of the film.

The copy of the film may be a particular copy made from a master copy, the watermark may be applied to the master copy, and the original mark may be applied to the portion of the particular copy which has the copy of the watermark that was applied to the master copy. The original mark may be unique to the particular copy. The particular copy may further be made from a master copy that was, in turn, made from a digital master to which the watermark had been applied.

Other aspects of the invention include methods for making the recoverable mark and methods for recovering an altered original mark from a recoverable mark.

### BRIEF DESCRIPTION OF THE DRAWING

These and other aspects, features and advantages of the present invention will become apparent from the following detailed description of preferred embodiments, which is to be read in connection with the accompanying drawings:

FIG. 1 is an overview of how a visible authentication pattern (VAP) is generated and inserted into a document;

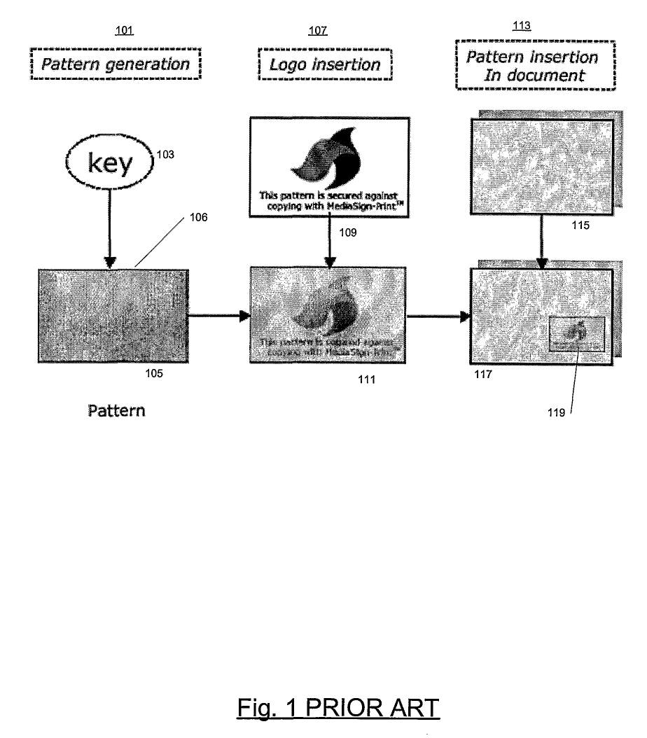

FIG. 2 is flowcharts showing how to make and recover a recoverable mark;

FIG. 3 is a block diagram of a system for incorporating recoverable marks into copies of films;

FIG. 4 shows a watermarked frame from a film;

FIG. 5 shows prior-art GUIs for watermark detection and alteration detection;

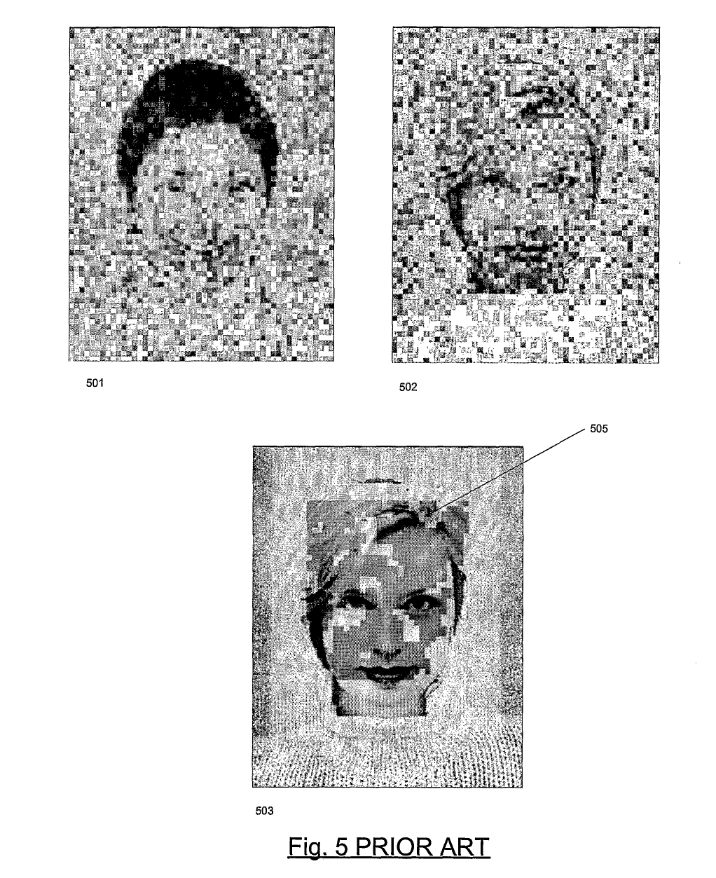

FIG. 6 is a block diagram of a prior-art technique for applying film marks to copies of films;

FIG. 7 is a diagram of a recoverable mark;

FIG. 8 shows a prior-art technique for using a message-based key to embed a contentless watermark in an image;

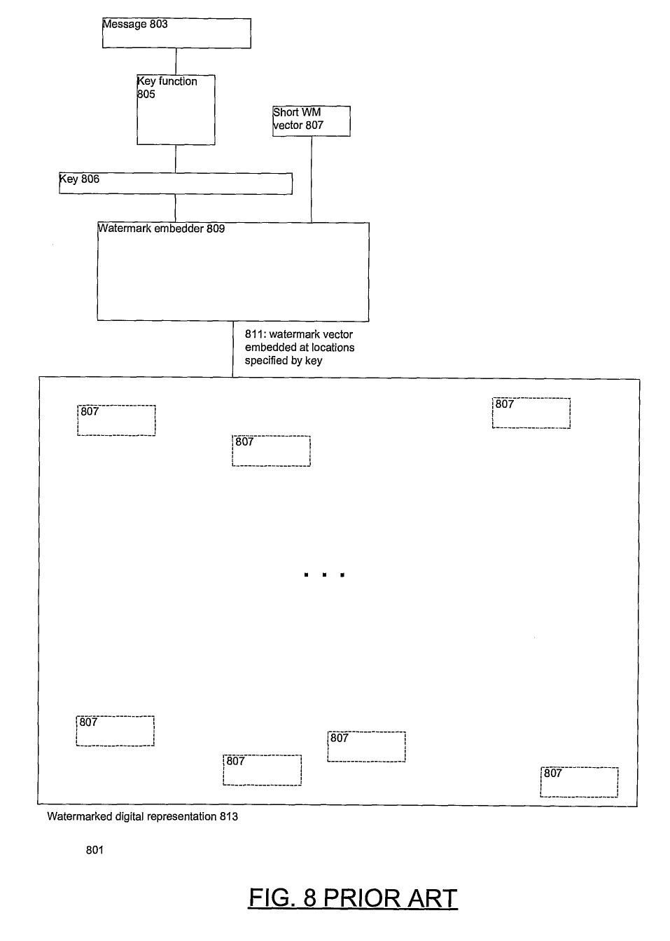

FIG. 9 shows a prior-art technique for determining whether a particular digital representation is derived from a digital representation which was watermarked using a message-based key;

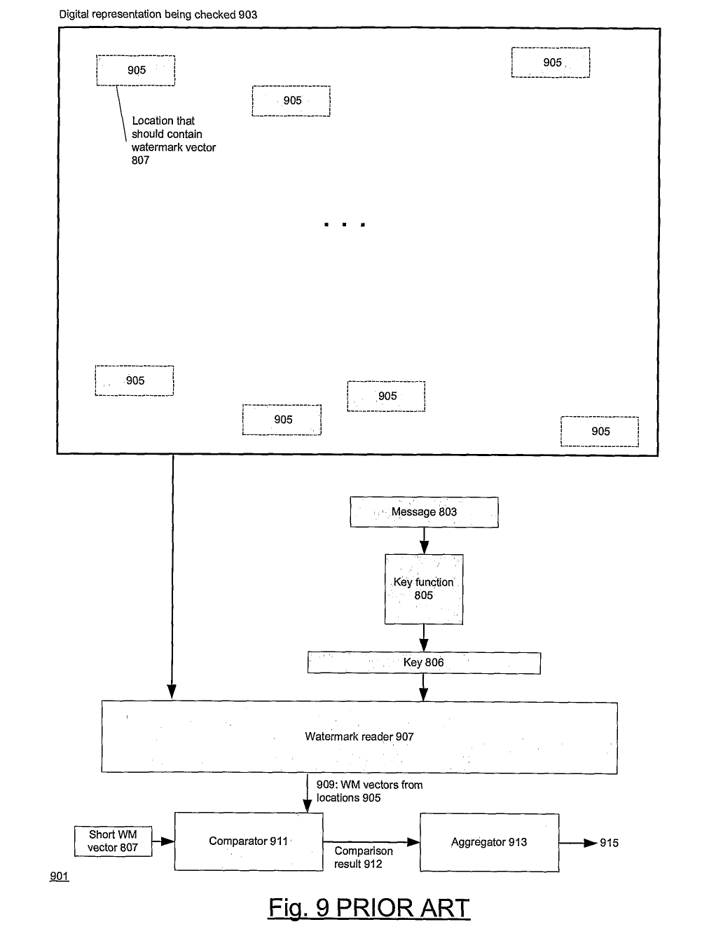

FIG. 10 shows how a VAP may be used to detect alteration of a document;

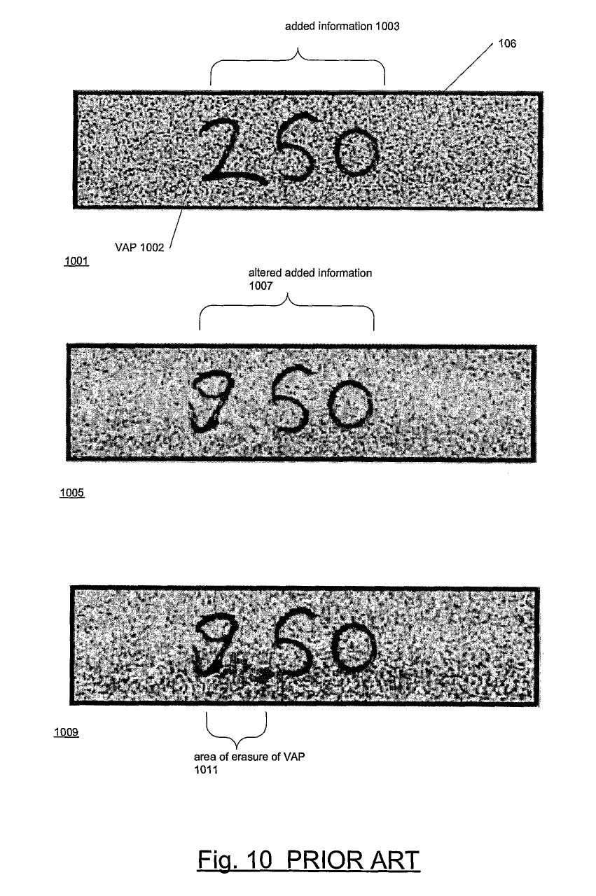

FIG. 11 shows how the watermark in a frame of a film makes it possible to recover a film mark in the frame;

FIG. 12 is a first example of how a film mark may be recovered; and

FIG. 13 is a second example of how a film mark may be recovered.

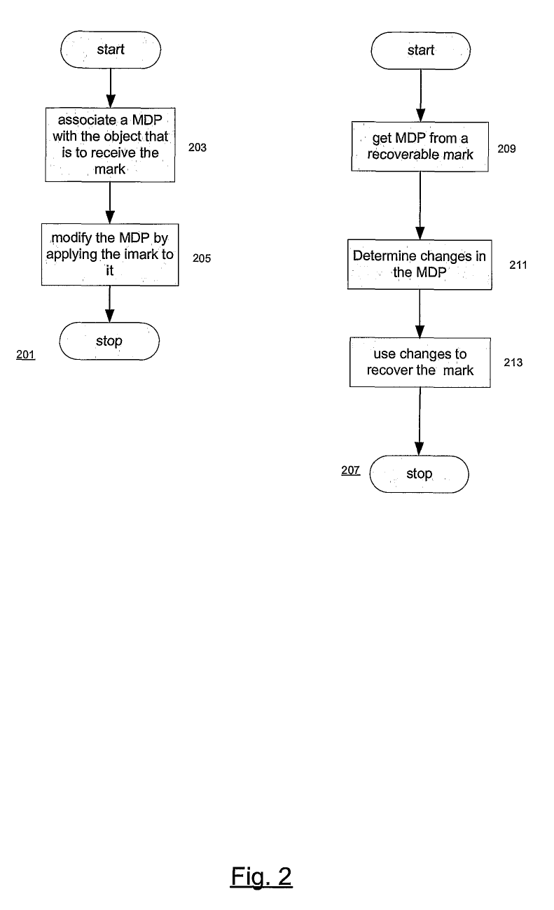

Reference numbers in the drawing have three or more digits: the two right-hand digits are reference numbers in the drawing indicated by the remaining digits. Thus, an item with the reference number 203 first appears as item 203 in FIG. 2.

### DETAILED DESCRIPTION OF THE PREFERRED EMBODIMENTS

In the foregoing, VAPs which have been used to detect modifications have been termed modification detection patterns. In the following, the concept of a modification detection pattern will be generalized to include any pattern which has the property that once the pattern is modified, the original form of the pattern cannot be determined without knowledge of the pattern prior to modification. The VAP is one example of such a pattern; watermarks that are used to detect modification of the watermarked image are another example of such a pattern. As can be seen from the foregoing, a modification detection pattern may either be visible, like a VAP, or invisible, like the watermarks that are used to detect modification of images. As already pointed out, watermarks used as modification detection patterns need not carry messages, and indeed, the shorter the message, the more robust the watermark, and for that reason, watermarks with short messages (including watermarks in which the message is 1 bit) are particularly useful for detection of alterations. As also already pointed out, one advantageous way of constructing modification detection patterns is to use a key to generate a pattern that is pseudo-random with regard either to the location of the watermark message in the object being watermarked or to the values of the pixels making up the pattern, as in a VAP. Certain terminology used in the following discussion has been defined in the discussion of VAPs above.

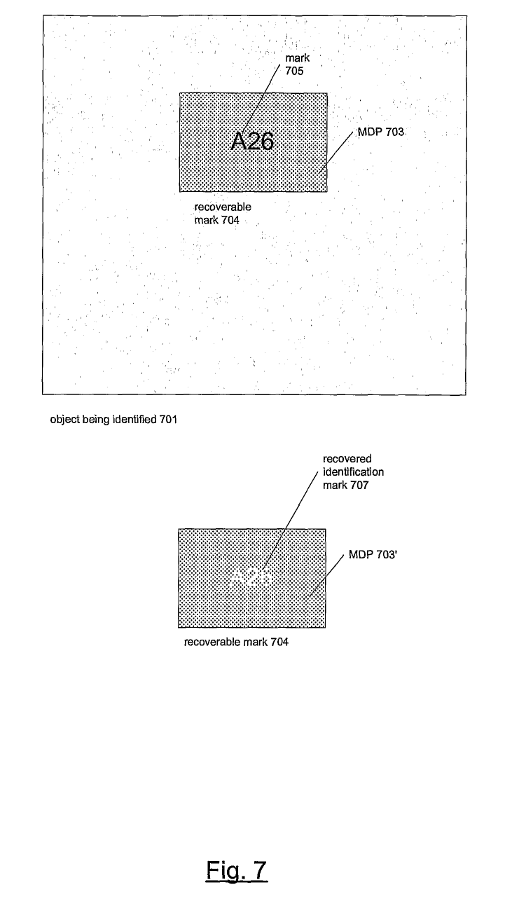

FIG. 7 shows a recoverable mark 704 associated with an object 701. Recoverable mark 704 has been made by applying a mark 705 to an MDP 703. The result of applying the mark 705 to MDP 703 is the modification of MDP 703 where the mark was applied to produce MDP 703′. When MDP 703′ is compared with MDP 703 as it was prior to the application of mark 705 to MDP 703′, the modification to MDP 703, namely mark 705, becomes visible as recovered mark 707. Because knowledge of MDP 703's pattern prior to the modification is not available to people other than the owner of object 701, a person who is attempting to remove mark 705 and then restore MDP 703′ to its previous condition will not be able to do so, and the removed mark will remain preserved in MDP 703′. Since attempts to alter mark 705 will further modify MDP 703′, those attempts will also be preserved in MDP 703′.

It should be noted here that mark 705 may be any kind of mark which modifies MDP 703′ in a way that can be detected by comparing it with MDP 703. For example, the mark may be an identification number that is printed on a VAP, a watermark that is added to the VAP when the VAP is printed, or a watermark that is added to an image that has already been watermarked with an MDP. In the case of the watermarks, the added watermark's pattern may, like the MDP's pattern, be known only to the owner of the object. The recoverable mark 704 made from mark 705 and MDP 703 may be completely digital, i.e., MDP 703 may be a digital pattern and mark 705 another digital pattern, it may be an analog version of a digital recoverable mark 704, or it may be made by adding an analog mark 705 to an analog version of a digital MDP 703, as when an analog mark is applied to a VAP. The technique can be applied in any situation where a noisy pattern exists or can be made and a mark applied to the noisy pattern. An aural example of the technique would be a portion of a recording which had been inaudibly watermarked and an audible mark applied over the inaudible watermark.

FIG. 2 shows a flowchart 201 for the construction of a recoverable mark and a flowchart 207 for recovering a mark 705 from a recoverable mark. As shown at 201, constructing a recoverable mark 704 is a matter of associating an MDP 703 with the object that is to receive the mark (203) and modifying the MDP by applying mark 705 to it (205). Where the marks 705 identify individual ones of a set of objects, all of the objects in the set may have the same MDP, for example, on a label attached to the object, and the mark for a given object may be applied to the MDP on that object's label.

Flowchart 207 shows how a mark may be recovered from a recoverable mark from a questionable object in which the mark appears to have been removed or altered. The MDP from the recoverable mark is obtained (209) from the questionable object. The changes in the MDP are determined (211) and the changes are used to recover the mark (213). As described in the discussions of using watermarks and VAPs to detect alterations, the changes in the MDP can be determined by comparing a digital original of the MDP as it existed prior to the modification and a digital version of the MDP after the modification, or by identifying areas where expected watermark signals are not present. If the recoverable mark's MDP is in analog form, its digital version will be made by digitizing the analog form.

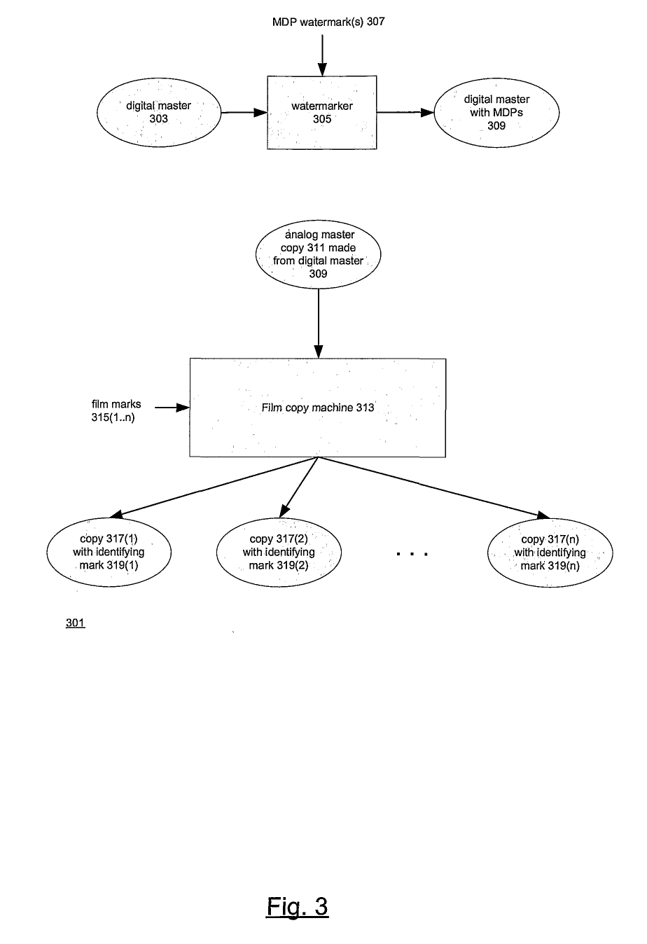

FIG. 3 shows how recoverable marks for copies of movies may be made using watermark MDPs and film marks. In system 301, a digital master 393 for the movie is watermarked with MDP watermarks 307 in watermarker 305. MDP watermarks 307 may be any kind of watermark, but robust watermarks such as ones with short messages are to be preferred because of the digital-to-analog conversion involved in the film copying process. The result of the watermarking is digital master with MDPs 309. Then an analog master copy 311 of the film is made from digital master 309 and copied using film copy machine 313. Film copy machine 313 also takes as inputs a film mark pattern 315 for each copy it makes. The pattern 315 is added to the copies of the portions of master 311 that have been watermarked with the MDPs 307 as the copies are made. The result is copies 317(1 . . . n) in which a film mark 315(i) has been combined with an MDP 307 to make a recoverable mark 319(i). As can be seen from the foregoing, the MDPs 307 are per-digital master, while the film mark 315 is per individual copy of the film.

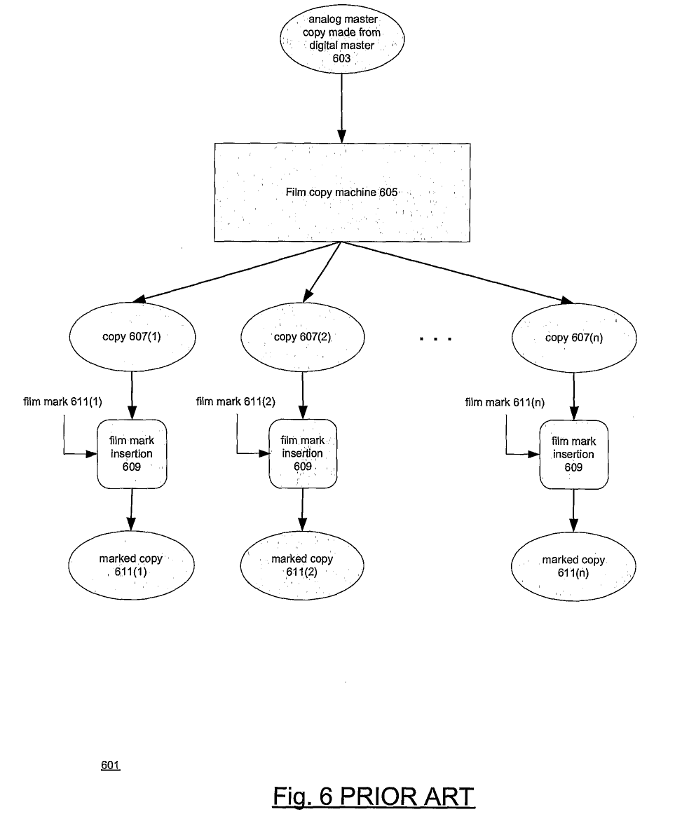

Of course, the film marks may also be added to the copies in a separate operation, in the manner shown in FIG. 6. The only requirement would be that the film marks be added to a part of the film that had an MDP 307.

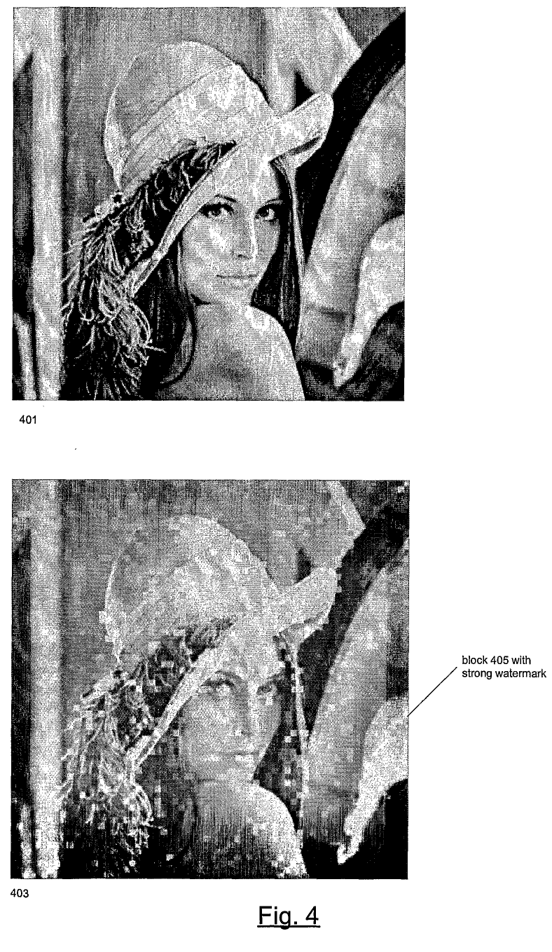

FIGS. 4, 11, 12, and 13 give examples of how recoverable marks made with MDPs 307 and film marks make it possible to both reconstruct film marks that have been deleted and to detect modified film marks. FIG. 4 shows a frame of a film 401 to which an MDP 307 has been added; as may be seen from frame 401, the MDP is not visible to the naked eye. At 403 is shown a view of frame 401 in which the strength of the watermark is measured in each block 405 of the digital representation of frame 401. In the color version of view 403, blocks 405 in which the watermark is normal do not change their color; blocks in which the watermark is strong appear in a green whose intensity increases with the strength of the watermark in the block; blocks in which there is no watermark at all appear in red. The complete lack of a watermark indicates that the watermark has been destroyed as a consequence of an alteration of that part of the frame. In frame 403, none of the blocks appear in red, so no part of the frame has been altered.

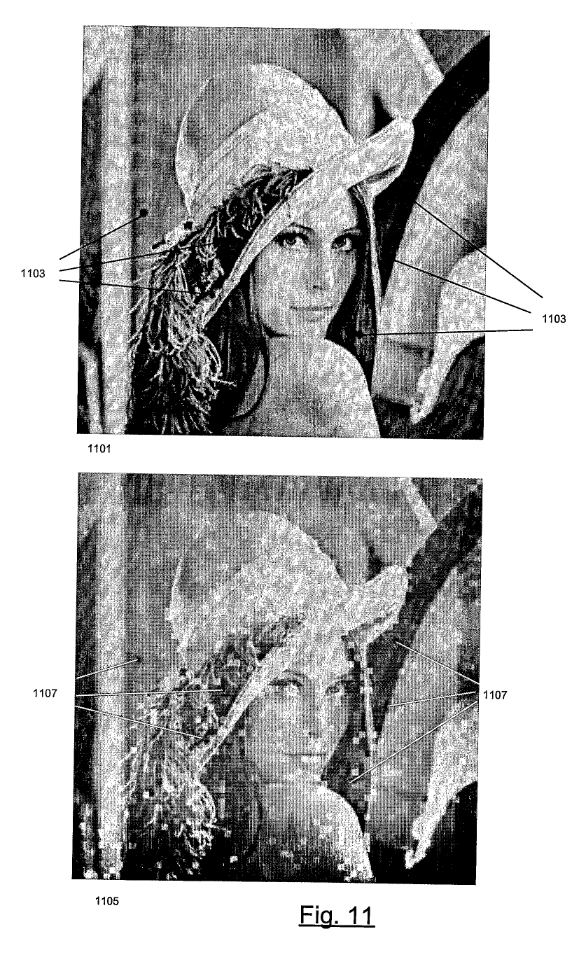

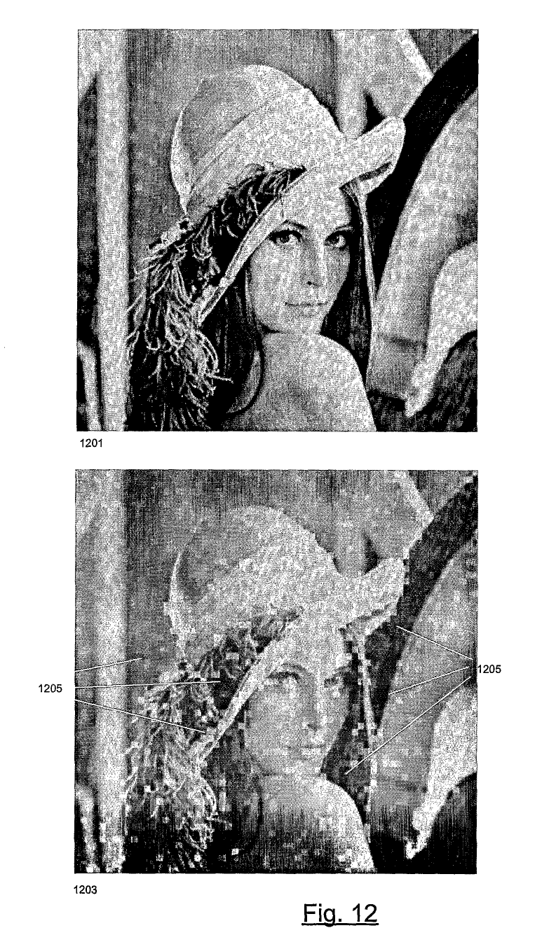

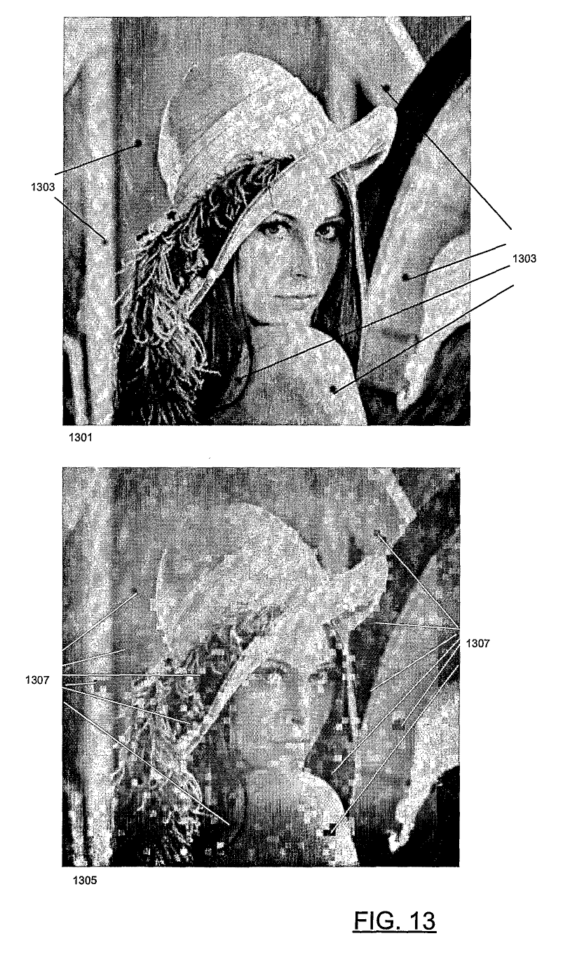

FIG. 11 shows a frame 1101 with an MDP 307 to which a film mark 1103 made up of 6 dots has been added. The combination of the MDP 307 and the film mark 1103 make frame 1101 into a recoverable mark for the film. At view 1105 is shown a view like view 1103. The difference is that there are 6 red spots 1107 at the locations of the dots of film mark 1103, as would be expected from the fact that the addition of film mark 1103 destroys the MDP 307 at the locations of the dots of film mark 1103. FIG. 12 shows a frame 1201 which originally had the same recoverable mark as frame 1101, but a pirate has removed film mark 1103 by painting over the mark's dots so that they match their surroundings in frame 1201. However, as shown in view 1203, painting over the dots cannot restore the parts of MDP 307 that were destroyed when the film mark was added, and consequently the six red spots 1205 still appear at the locations of film mark 1103's dots in view 1203. FIG. 13, finally, shows a frame 1301 which originally had the same recoverable mark as frame 1101, but the pirate has painted over the six dots of the original film mark and added six new dots of his own, as may be seen when film mark 1303 is compared with film mark 1103. As one would expect, the parts of MDP 307 that were destroyed by the addition of the dots of the original film mark remain destroyed, and the addition of the six new dots has destroyed the parts of MDP 307 at those locations; consequently, view 1305 shows 12 red marks 1307.

Recoverable marks may also be applied to streaming video. The original mark may be an overlay (such as a logo, text, visible graphical patterns, . . . ) over the video that is added in real time. This can be done in either baseband or in the compressed domain of a video:

1) in baseband: This can be done easily and cheaply with screen display mechanisms available on set-top-boxes, digital TVs, digital cinema projectors, and other display devices. The visible graphical pattern that is the original mark in this context is overlaid on the video content. This technique is very useful for following applications:
video on demand, IPTV, . . . in which the video is delivered to a hotel (chain), airline, individual subscriber or purchaser. In this case, a unique visible pattern identifying the receiver of the video can be overlaid on the decoded video (baseband video) which is delivered for display.
broadcasting applications where a visible graphical such as a logo can be overlaid to the video for identifying the receiver (e.g. a local station, or an international version).
   2) in compressed form (e.g. MPEG2, H264, JPEG2000): This can be done by manipulating certain coefficients (DCT coefficients for MPEG2 and H264, and wavelet coefficients for JPEG2000) to create original marks which are visible effects or patterns (such as stripes, a bright/dark spot, . . . ). This is useful in some applications because the original marks are added before decoding and saving the video to the hard disk. A lot of piracy occurs after the video content has been saved to the hard drive.

The foregoing Detailed Description of the Preferred Embodiments has disclosed to those skilled in the relevant technologies how to make and use the recoverable marks described herein. It will be immediately apparent to those skilled in the relevant technologies that many implementations of the techniques described herein are possible. For example, recoverable marks analogous to those described in the Detailed Description of the Preferred Embodiments may be made and used in audio media. In such a case, the recoverable mark would include an inaudible watermark in a portion of the audio media and an audible original mark in that portion. The techniques may further be applied to films reproduced in digital media as well as films reproduced in analog media and to films distributed via streaming technologies as well as to films that are distributed as physical objects such as reels of film or DVDs. The recoverable mark's watermark may be any form of watermark which is modified by application of the original mark to the portion of the film or other object containing the recoverable watermark and the original mark may be any kind of mark whose application modifies the watermark. The watermark and the original mark may each be applied at any stage of the film copying and distribution process that makes technical and business sense. Recovering an altered original mark from the recoverable watermark may involve any technique which makes the modifications in the watermark perceptible.

For all of the foregoing reasons, the Detailed Description of the Preferred Embodiments is to be regarded as being in all respects exemplary and not restrictive, and the breadth of the invention disclosed herein is to be determined not from the Detailed Description of the Preferred Embodiments, but rather from the claims as interpreted with the full breadth permitted by the patent laws.

1. A method of making a recoverable mark on a portion of a film, the method comprising:
applying a watermark that is imperceptible to viewers thereof to the portion of the film; and
modifying the watermark by applying an original mark to at least one of the portion of the film and a copy of the portion of the film.

2. The method set forth in claim 1 wherein the original mark is at least one hole in at least one of the portion of the film and the copy of the portion of the film.

3. The method set forth in claim 1 wherein the original mark is made by discoloring dye in at least one of the portion of the film and the copy of the portion of the film.

4. The method set forth in claim 1 wherein the original mark is another watermark that has been applied to at least one of the portion of the film and the copy of the portion of the film.

5. The method set forth in claim 1 wherein:
the film is a particular copy of the film made from a master copy of the film;
said applying act is performed on the master copy of the film; and
in the act of modifying, the original mark is applied to the portion of the particular copy of the film which has the copy of the watermark that was applied to the master copy of the film.

6. The method set forth in claim 5 wherein the original mark is unique to the particular copy of the film.

7. The method set forth in claim 1 wherein the watermark is applied to a portion of a digital master of the film, the method further comprises:
making an analog master copy of the film from the digital master; and
in the act of modifying the watermark, the original mark is applied to the portion in a further copy of the film made from the analog master copy of the film.

8. The method set forth in claim 7 wherein the original mark uniquely identifies the further copy of the film.

9. A method of recovering an original mark that has been altered from a recoverable mark on a portion of a film, the recoverable mark being a watermark that is imperceptible to viewers thereof on the portion of the film and the original mark, application of the original mark to the portion having modified the watermark, the method comprising:
determining locations of modifications of the watermark in the portion of the film; and
using the locations of the modifications of the watermark to recover the original mark.

10. The method set forth in claim 9 wherein using locations of modifications of the watermark includes comparing the watermark which has been modified by applying the mark thereto with an example of the watermark that has not been so modified.

11. The method set forth in claim 10 wherein in said comparing act, a digital representation of the recoverable mark whose original mark has been altered is compared with a digital representation of the example watermark.

12. The method set forth in claim 11 further comprising making the digital representation of the recoverable mark whose original mark has been modified.

13. The method set forth in claim 9 wherein the mark is at least one hole in the portion of the film.

14. The method set forth in claim 9 wherein the mark is made by discoloring dye in the portion of the film.

15. The method set forth in claim 9 wherein the mark is another watermark that has been applied to the portion of the film.

16. The method set forth in claim 9 wherein:
the film is a particular copy of the film made from a master copy of the film;
the watermark was applied to the master copy of the film; and
the original mark was applied to the portion of the particular copy of the film which has the copy of the watermark that was applied to the master copy of the film.

17. The method set forth in claim 16 wherein the original mark is unique to the particular copy of the film.

18. A recoverable mark associated with a copy of a film comprising:
a portion of the copy of the film which carries a watermark that is imperceptible to viewers of the copy of the film; and
an original mark, the watermark having been modified by applying the original mark to the portion of the copy of the film.

19. The recoverable mark set forth in claim 18 wherein the original mark is one or more holes in the portion of the copy of the film.

20. The recoverable mark set forth in claim 18 wherein the original mark is made by discoloring dye in the portion of the copy of the film.

21. The recoverable mark set forth in claim 18 wherein the original mark is another watermark that has been applied to the portion of the copy of the film.

22. The recoverable mark set forth in claim 18 wherein:
the copy of the film is a particular copy of the film made from a master copy of the film;
the watermark is applied to a portion of the master copy of the film; and
the original mark is applied to the portion of the particular copy of the film which has the copy of the watermark that was applied to the portion of the master copy of the film.

23. The recoverable mark set forth in claim 22 wherein the original mark is unique to the particular copy of the film.

24. The recoverable mark set forth in claim 18 wherein;
the watermark is applied to a portion of a digital master of the film; and
the original mark is applied to the portion in a further copy of the film made from an analog master copy of the film, the analog master copy of the film being made from the digital master of the film.

25. The recoverable mark set forth in claim 24 wherein the original mark uniquely identifies the further copy of the film.
